(19) United States
(12) Patent Application Publication
(10) Pub. No.: US 2017/0349410 A1
(43) Pub. Date: Dec. 7, 2017

(54) Modular Elevator Sheave

(71) Applicants: Xu Ming WEN, Shaoxing City (CN); Gui Lin LIANG, Shaoxing City (CN); Ming Wei WANG, Shaoxing City (CN); Fang Chi ZHANG, Shaoxing City (CN); Chun Lan YU, Shaoxing City (CN)

(72) Inventors: Xu Ming WEN, Shaoxing City (CN); Gui Lin LIANG, Shaoxing City (CN); Ming Wei WANG, Shaoxing City (CN); Fang Chi ZHANG, Shaoxing City (CN); Chun Lan YU, Shaoxing City (CN)

(21) Appl. No.: 15/595,955

(22) Filed: May 16, 2017

(30) Foreign Application Priority Data
Jun. 7, 2016 (CN) 201620548539.5

(51) Int. Cl. B66B 15/02

(52) U.S. Cl. CPC B66B 15/02

(57) ABSTRACT

A modular elevator sheave comprises a mandrel body, wherein multiple sheave units are arranged side by side along the mandrel body, and wherein, the outer wall of the outer circumference of the sheave unit is provided with a groove. In this structural composition, the mandrel body with multiple sheave units, which increases the overall strength and rigidity of the sheave. Furthermore, the number of sheave unit used can be increase and decrease depending on the need or situation, and it should be noted that since the sheave unit can be replaced individually when damaged, it is easier to maintain and reduce repairing costs.

### BACKGROUND OF THE INVENTION

### 1. Field of the Invention

The present invention relates generally to sheaves for guiding cables in the elevators, especially to a modular elevator sheave unit.

### 2. Description of Related Art

Commerical elevators typically use multiple of cable sheaves as part of driving system to operate elevetor cart. A typical elevator sheave is shown as FIG. 1, it generally comprises a mandrel body having a bearing on both ends, and a sheave unit is attached to the bearing. The sheave unit may have multiple grooves between two flanges around its circumference for which the drive elements of a commerical elevator, such as ropes, cables or belts that run over the sheave unit inside the grooves. Typically, the number of grooves inside the sheave unit is fixed so that the number of drive elements can be used is limited to the number of grooves. In addition, because the speed of each drive elements that run over the grooves might be inconsistent which causes slips among the drive elements, which would generate noise and shorten usage life of the sheave unit or drive elements.

### SUMMARY OF THE INVENTION

The present invention provides a solution to the above-identified problems by providing a modular elevator sheave. The sheave comprises a mandrel body, where multiple sheave units are provided on the mandrel body to increase the strength and rigidity of the overall sheave. More specific,the number of sheave units provided on the mandrel body can be easily increased and decreased depending on the need. Furthermore,the sheave units can be replaced individually when damaged, therefore, simplified the overall sheave design, and it is easier to maintain and reduce repairing costs.

In order to achieve above-identified benefits, the present invention provides a modular elevator sheave comprises a mandrel body and multiple sheave units arranged side by side along the mandrel body. Wherein, a groove is provided about the center of the outer wall of the outer circumference of the of each sheave units. Wherein, the inner wall of the inner circumference of the sheave unit and the outer wall of the mandrel body forms a transit fit for the selected drive element.

Wherein, the end faces of the inner circumference of any two adjacent sheave units are oppressed with each other, and the end faces of the outer circumference of any two adjacent sheave units are apart from each other.

Wherein, the sheave unit comprises an outer circumference, an inner circumference, a fixing frame, two rows of ball body and a seal ring. The seal ring is provided in between the outer circumference and the inner circumference, and the two rows of ball body are provided on respectively on the grooves of the two ends of the sheave unit and the fixing frame secures the two rows of ball body within the sheave unit.

Wherein, the groove bottom of groove of the outer circumference is curved and the angle between the groove bottom and the two side wall of the groove is a curved transition fit wall.

The inner walls of the two end faces of the outer circumference 1 and the inner circumference are provided with installation grooves, wherein, the seal ring is embedded within the respective installation groove, wherein, the seal ring is clamped in between the outer circumference and the inner circumference.

The mandrel body is provided with multiple abrasion resistance paddings, the abrasion resistance padding are arranged in between the end faces of the inner circumferences of any two adjacent sheave unit.

The advantages that the present invention provides are: comparing to the current structure characteristics, the present invention provides the mandrel body with multiple sheave units, which increases the overall strength and rigidity of the sheave. Furthermore, the number of sheave unit used can be increase and decrease depending on the need or situation, and it should be noted that since the sheave unit can be replaced individually when damaged, it is easier to maintain and reduce repairing costs.

### BRIEF DESCRIPTION OF THE DRAWINGS

FIG. 1 is a structural illustration of current elevator sheave;

FIG. 2 is a structural illustration of the present invention; and

FIG. 3 is a structural illustration of the sheave unit of the present invention

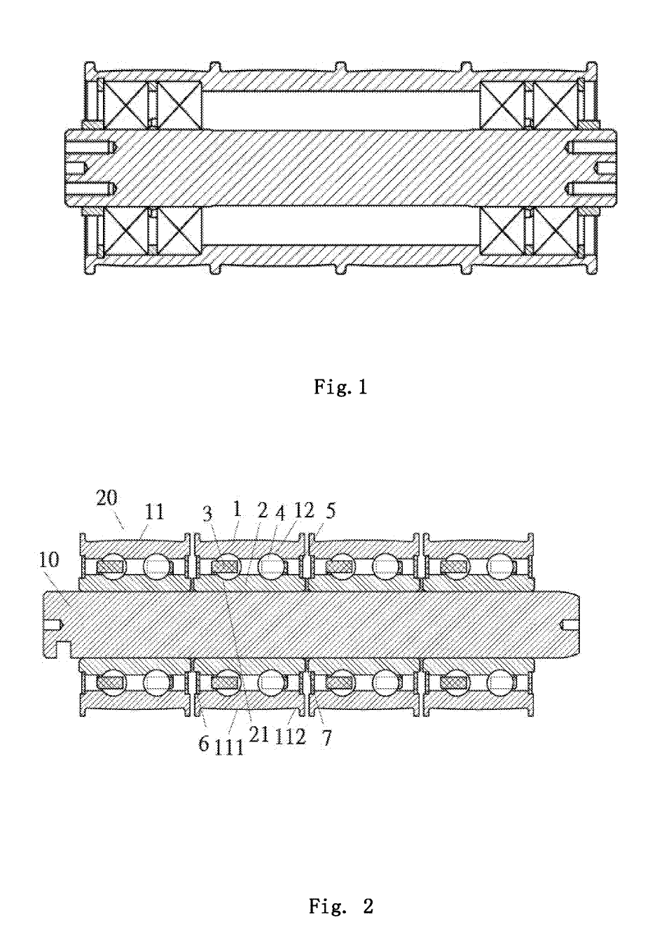

### DETAILED DESCRIPTION OF THE INVENTION

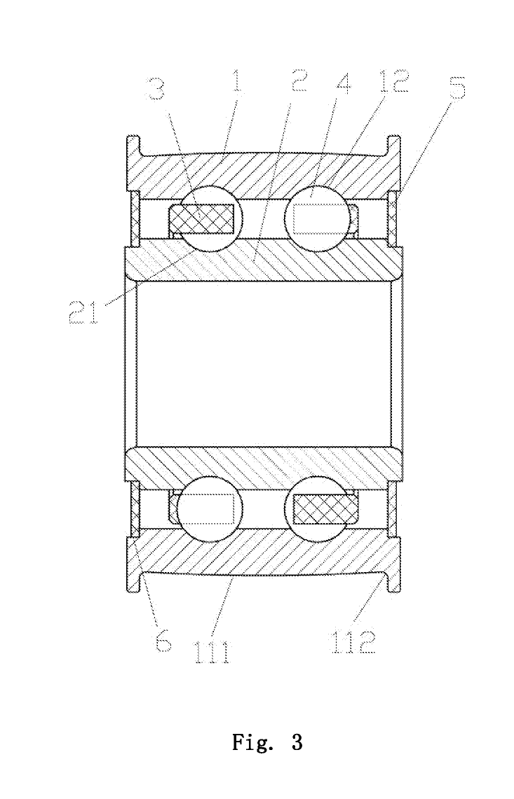

As shown in FIG. 2 and FIG. 3, the present invention a modular elevator sheave comprises a mandrel body 10, wherein multiple sheave units 20 are arranged side by side along the mandrel body 10, and wherein, the outer wall of the outer circumference 1 of the sheave unit 20 is provided with a groove 11.

As a preferred embodiment, the inner wall of the inner circumference 2 of the sheave unit 20 and the outer wall of the mandrel body 10 forms a transit fit for the selected drive element.

As a preferred embodiment, the end faces of the inner circumference 2 of any two adjacent sheave units 20 are oppressed with each other, and the end faces of the outer circumference 1 of any two adjacent sheave units 20 are apart from each other.

As a preferred embodiment, the sheave unit 20 comprises an outer circumference 1, an inner circumference 2, a fixing frame 3, two rows of ball body 4 and a seal ring 5. The seal ring 5 is provided in between the outer circumference 1 and the inner circumference 2, the two rows of ball body 4 is respectively provided on the left and right side of inner groove 12 of the outer circumference 1 and the left and right side of outer grooves 21 of the inner circumference 2. Wherein, the fixing frame 3 secures the two rows of ball body 4 in between the outer circumference and the inner circumference.

As a preferred embodiment, the groove bottom 111 of the groove 11 of the outer circumference is curved, and the angle between the groove bottom 111 and the two side wall of the groove 11 is a curved transition fit wall 112.

As a preferred embodiment, the inner walls of the two end faces of the outer circumference 1 and the inner circumference 2 are provided with installation grooves 6, wherein, the seal ring 5 is embedded within the respective installation groove 6, wherein, the seal ring 5 is clamped in between the outer circumference 1 and the inner circumference 2.

As a preferred embodiment, the mandrel body 10 is provided with multiple abrasion resistance paddings 7, the abrasion resistance padding 7 are arranged in between the end faces of the inner circumferences 2 of any two adjacent sheave unit 20.

As a preferred embodiment, multiple sheave units 20 are arranged side by side along the mandrel body 10. Jump rings can be used on the two ends of the mandrel body 10 to secure the sheave units 20 with the mandrel body 10. Other securing methods, such as panel fixing can be adapted, however, these methods may be considered as current arts and will not be discussed.

As described above, the present invention provides the mandrel body 10 with multiple sheave units 20, which increases the overall strength and rigidity of the sheave unit. Furthermore, the number of sheave unit 20 used can be increase and decrease depending on the need or situation, and it should be noted that since the sheave unit 20 can be replaced individually when damaged, it is easier to maintain and reduce repairing costs.

Furthermore, the present invention provides that the groove bottom 111 of groove 11 of the outer circumference 1 is curved and the angle between the groove bottom 111 and the two side wall of the groove 11 is a curved transition fit wall 112, which, reduces the friction of the drive element on the groove bottom 111 and increases usage life of the sheave unit 20.

Furthermore, the present invention provides the abrasion resistance paddings 7 arranged in between the end faces of the inner circumferences 2 of any two adjacent sheave unit 20, which reduces the friction between any two adjacent sheave units 20 and further increases usage life of the sheave unit 20.

1. A modular elevator sheave comprising: a mandrel body, wherein said mandrel body is provided with a multiple number of sheave units arranged side by side along the mandrel body, and wherein,each of said sheave units is provided with a groove about the center of the outer wall of the outer circumference.

2. The modular elevator sheave as claimed in claim 1, wherein, the inner wall of the inner circumference of the sheave unit and the outer wall of the mandrel body forms a transit fit for a selected drive element.

3. The modular elevator sheave as claimed in claim 1, wherein, the end faces of the inner circumference of any two adjacent sheave units are oppressed with each other, and the end faces of the outer circumference 1 of any two adjacent sheave units are apart from each other.

4. The modular elevator sheave as claimed in claim 1, wherein, said sheave unit comprising an outer circumference, an inner circumference, a fixing frame, two rows of ball body and a seal ring; said seal ring is provided in between the outer circumference and the inner circumference, the two rows of ball body is respectively provided on the left and right side of inner groove of the outer circumference and the left and right side of outer grooves of the inner circumference; wherein, the fixing frame secures the two rows of ball body in between the outer circumference and the inner circumference.

5. The modular elevator sheave as claimed in claim 1, wherein, the groove bottom of the groove of the outer circumference is curved, and the angle between the groove bottom and the two side wall of the groove is a curved transition fit wall.

6. The modular elevator sheave as claimed in claim 1, wherein, the inner walls of the two end faces of the outer circumference and the inner circumference are provided with installation grooves, wherein, the seal ring is embedded within the respective installation groove, wherein, the seal ring is clamped in between the outer circumference and the inner circumference.

7. The modular elevator sheave as claimed in claim 1, wherein, the mandrel body is provided with multiple abrasion resistance paddings, wherein the abrasion resistance padding are arranged in between the end faces of the inner circumferences of any two adjacent sheave unit.
